(19) United States
(12) Patent Application Publication
(10) Pub. No.: US 2016/0221623 A1
(43) Pub. Date: Aug. 4, 2016

(54) BICYCLE KICK STAND-COMBINED PUMP AND KICK STAND HAVING DETACHABLE PUMP

(71) Applicant: Pil Ho KIM, Jung-gu, Seoul (KR)

(72) Inventor: Pil Ho KIM, Seoul (KR)

(21) Appl. No.: 15/029,479

(22) PCT Filed: Dec. 9, 2014
(86) PCT No.: PCT/KR2014/012062

§ 371 Date: Apr. 14, 2016

(30) Foreign Application Priority Data
Dec. 18, 2013 (KR) 10-2013-0158459
Dec. 18, 2013 (KR) 10-2013-0158471

(51) Int. Cl. B62H 1/02; B62K 19/42

(52) U.S. Cl. CPC B62H 1/02; B62K 19/42

(57) ABSTRACT

Disclosed are a bicycle kickstand-combined pump and a kickstand having a detachable pump. The bicycle kickstand-combined pump may include: an assembly plate tightened and assembled by the quick release lever device; a rotating unit coupled to the assembly plate and provided with a rotating shaft so as to be rotatable between a parking position and a moving position; and a pump installed to extend from a lower end of the rotating unit. The kickstand may include: an assembly plate tightened and assembled by the quick release lever device; a rotating unit coupled to the assembly plate and provided with a rotating shaft so as to be rotatable between a parking position and a moving position; and a pump detachably assembled to a lower end of the rotating unit so as to be assemblable with and disassemblable from each other.

### TECHNICAL FIELD

The present invention relates to a bicycle kickstand-combined pump and a kickstand having a detachable pump and, more particularly, a bicycle kickstand-combined pump and a kickstand having a detachable pump which can be assembled with a quick release lever device, and which can be used as a kickstand under normal conditions and may be separated from the bicycle and used as a pump when there is the need of injection of air into a tire.

### BACKGROUND ART

Generally, in the case of a two-wheeled vehicle, typically, a bicycle, other than a four-wheeled vehicle, a kickstand is fixed to and installed on a frame for a rear wheel so as to support the bicycle in an upright position when parking, because the bicycle has only two wheels.

The kickstand is configured such that when parking the bicycle, one end of the kickstand is on the ground and the other end thereof is coupled to the bicycle so as to support the bicycle, whereby the bicycle can be kept upright in an inclined state.

The kickstand is operated according to a general usage in which when it is desired to move the bicycle, a user pushes the kickstand using his/her foot and rotates it rearward to 90 degrees to make the kickstand horizontal.

Furthermore, the kickstand is configured such that when the user uses his/her foot and pushes, for parking, the kickstand that has been in the horizontal state, the kickstand is rotated to be returned to the above-mentioned parking state.

Such a kickstand is seldom used for other purposes other than for its intended purpose as a kickstand. Furthermore, recently, according to a bicycle design trend to reduce the weight of a bicycle, parts which are not necessary to operate the bicycle are being omitted. Thus, among bicycles that are sold on the market, there are many bicycles having no kickstand.

A kickstand for a bicycle according to a conventional art is problematic in that because it has another function other than the purpose of allowing the bicycle to be kept upright when parking, it has little functional effect in consideration of an increase in weight of the bicycle.

Generally, bicycles are moved with two wheels. Given this, when a tire is flat or the air pressure in the tire is low, the tire must be inflated. In this case, a pump for supplying air into the tire is required. A typical pump is configured such that it is removably coupled to a part of a frame of the bicycle through a predetermined type holder.

As such, the bicycle according to the conventional art is configured to make the user have to carry a separate pump or to be removably coupled to the frame of the bicycle through the holder. In the case of the configuration using the separate holder, there is a problem in that the weight of the bicycle is increased.

To overcome the above-mentioned problems of the conventional art, a related technique was proposed in Chinese Utility Model Unexamined Publication No. 2077493. In this Utility Model, a pump for bicycles which can be used for various purposes was introduced. The pump of this Utility Model is configured to be used not only as a pump by being coupled to pedals of a bicycle but also as a kickstand.

However, the pump for bicycles according to this conventional art has a complex structure with a large number of parts and thus goes against the recent trend to reduce the weight of the bicycle. Moreover, there are problems in that a method for using the pump is very complex and difficult, and much time it takes to separate the pump from the bicycle is required.

### DISCLOSURE

### Technical Problem

Various embodiments are directed to a bicycle kickstand-combined pump which is assembled with a quick release lever device and thus can be easily coupled to or separated from a bicycle, and which can be used as a pump in such a way that it is separated from the bicycle and then a portion thereof is bent by 90 degrees and used as a foothold.

Also, various embodiments are directed to primarily reducing the weight by combination of a kickstand and a pump, secondarily reducing the weight by the configuration in which there is no separate coupling device because a quick release lever is used to couple the kickstand-combined pump to the bicycle or separate it therefrom, and improving convenience of use.

Further, various embodiments are directed to a kickstand having a detachable pump which is installed on a quick release lever device and is configured such that the pump is detachably coupled to the lower end of the kickstand, so that the kickstand can be used for its intended purpose and also used as a pump after being separated from the bicycle when needed.

### Technical Solution

In an embodiment, a bicycle kickstand-combined pump assembled to a bicycle by a quick release lever device by which a rear wheel of the bicycle is assembled to a frame may include: an assembly plate tightened and assembled by the quick release lever device; a rotating unit coupled to the assembly plate and provided with a rotating shaft so as to be rotatable between a parking position and a moving position; and a pump installed to extend from a lower end of the rotating unit.

An upper end of the pump may be inserted into the lower end of the rotating unit, and a tension spring may be installed therebetween.

Hinge members may respectively protrude from the lower end of the rotating unit and an upper end of the pump and be coupled to each other so as to be rotatable by a hinge shaft. A hole may be formed in the hinge member of the pump and have a rectangular upper part and a circular lower part, and the hinge shaft may have a rectangular end. A plurality of protrusions may be provided on the assembly plate and thus increase frictional force to prevent the assembly plate from being removed after assembly.

A discharge portion may be provided on a side surface of a body of the pump so that compressed air is discharged from the pump through the discharge port.

Threaded parts may be formed on an inner surface of a cylinder pipe of the pump and an outer surface of a piston pipe of the pump so that the piston pipe is prevented from being moved downward by its own weight.

A wire hole may be formed in the assembly plate so that a wire of a locking device for anti-theft purpose can pass through the assembly plate through the wire hole.

In another embodiment, a kickstand having a detachable pump, assembled to a bicycle by a quick release lever device by which a rear wheel of the bicycle is assembled to a frame, may include: an assembly plate tightened and assembled by the quick release lever device; a rotating unit coupled to the assembly plate and provided with a rotating shaft so as to be rotatable between a parking position and a moving position; and a pump detachably assembled to a lower end of the rotating unit so as to be assemblable with and disassemblable from each other.

A plurality of protrusions may be provided on the assembly plate and thus increase frictional force to prevent the assembly plate from being removed after assembly.

A discharge portion may be provided on a side surface of a body of the pump so that compressed air is discharged from the pump through the discharge port.

Threaded parts may be formed on an inner surface of a cylinder pipe of the pump and an outer surface of a piston pipe of the pump so that the piston pipe is prevented from being moved downward by its own weight.

A nut may be provided on any one of the lower end of the rotating unit and an upper end of the pump, and a bolt may be provided on the other so that the rotating unit and the pump are assembled with each other.

A central depression may be formed in a central portion of the lower end of the rotating unit, and a central protrusion may be provided on an upper end of the pump and inserted into the central depression. A plurality of O-rings may be fitted over an outer surface of the central protrusion so that the rotating unit and the pump are assembled with each other by force-fitting.

A central depression may be formed in a central portion of the lower end of the rotating unit. A central protrusion may be provided on an upper end of the pump and inserted into the central depression. A locking pin may be assembled with the rotating unit and the pump through the central depression and the central protrusion. The locking unit may include: an outer pipe provided with a stop protrusion on an end thereof; an operating rod inserted into the outer pipe; a spring configured to push the operating rod outward; a locking bolt fixed to an end of the operating rod and configured to prevent the operating rod from being removed from the outer pipe; and a plurality of balls inserted into a plurality of side holes formed in a side surface of the outer pipe. When the locking pin is at a locked position, a portion of each of the balls may be disposed in the corresponding side hole of the outer pipe, and another portion thereof may protrude outward from the side hole. When the locking pin is at a separation position, the ball may be disposed in a reduced diameter part of the operating rod and thus completely inserted inside the side hole so as to allow the locking pin to be removed from the central depression and the central protrusion.

### Advantageous Effects

The present invention has the following effects.

(1) The bicycle kickstand-combined pump according to the present invention can primarily reduce the weight by combination of a kickstand and a pump and secondarily reduce the weight by the configuration in which there is no separate coupling device because a quick release lever is used to couple the kickstand-combined pump to the bicycle or separate it therefrom.

(2) The bicycle kickstand-combined pump according to the present invention is configured such that it is installed so as to be detachable along with a rear wheel by the quick release lever device. Therefore, the kickstand-combined pump can be rapidly and conveniently separated from the bicycle and used as a pump.

(3) The bicycle kickstand-combined pump according to the present invention is configured such that it is separated from the quick release lever and then a portion thereof is bent by 90 degrees to allow a user to step on the bent portion and use the present invention as a pump. Therefore, the kickstand-combined pump can discharge a high pressure of air and thus inflate a tire with air of a sufficient pressure.

(4) In the bicycle kickstand-combined pump according to the present invention, an assembly plate which is coupled with the quick release lever device has at a predetermined position a wire hole through which a wire of a locking device can pass, thus providing an anti-theft function.

(5) The bicycle kickstand-combined pump according to the present invention can not only be used as a kickstand under normal conditions but can also be used as a pump after being separated from the bicycle when needed. Therefore, it is convenient because there is no need of carrying a separate pump.

(6) Because the bicycle kickstand-combined pump according to the present invention is a part which is assembled with the bicycle by the quick release lever, the user can rapidly and easily separate the kickstand-combined pump from the bicycle, selectively.

### BRIEF DESCRIPTION OF DRAWINGS

FIG. 1 is a perspective view illustrating a state in which a bicycle kickstand-combined pump according to a first embodiment of the present invention is positioned at a parking position.

FIG. 2 is a perspective view illustrating a state in which the bicycle kickstand-combined pump according to the first embodiment of the present invention is positioned at a moving position.

FIG. 3 is an exploded perspective view showing the bicycle kickstand-combined pump according to the first embodiment of the present invention separated from a bicycle.

FIG. 4 is a perspective view of the bicycle kickstand-combined pump according to the first embodiment of the present invention.

FIG. 5 is an exploded perspective view of the bicycle kickstand-combined pump according to the first embodiment of the present invention.

FIG. 6 is a partially sectional view showing an example of the use of the bicycle kickstand-combined pump according to the first embodiment of the present invention.

FIG. 7 is a perspective view of a bicycle kickstand-combined pump according to a first embodiment of the present invention.

FIG. 8 is a perspective view of a bicycle kickstand-combined pump according to a third embodiment of the present invention.

FIG. 9 is an exploded perspective view of the bicycle kickstand-combined pump according to the third embodiment of the present invention.

FIG. 10 is a perspective view of a bicycle kickstand-combined pump according to a fourth embodiment of the present invention.

FIG. 11 is a partially sectional view showing an example of the use of the bicycle kickstand-combined pump according to the first embodiment of the present invention.

FIG. 12 is a perspective view illustrating a state in which a kickstand having a detachable pump according to a first embodiment of the present invention is positioned at a parking position.

FIG. 13 is a perspective view illustrating a state in which the kickstand having the detachable pump according to the first embodiment of the present invention is positioned at a moving position.

FIG. 14 is an exploded perspective view showing the kickstand having the detachable pump according to the first embodiment of the present invention separated from a bicycle.

FIG. 15 is a perspective view of the kickstand having the detachable pump according to the first embodiment of the present invention separated from a bicycle.

FIG. 16 shows a partially sectional view and an enlarged view of the kickstand having the detachable pump according to the first embodiment of the present invention.

FIG. 17 is a partially sectional view illustrating a kickstand having a detachable pump according to a second embodiment of the present invention.

FIG. 18 shows a partially sectional view and an enlarged view of a kickstand having a detachable pump according to a third embodiment of the present invention.

FIG. 19 shows a sectional view and a partially enlarged view of a locking pin of the kickstand having the detachable pump according to the third embodiment of the present invention.

### MODE FOR INVENTION

The above-described aspects, features and advantages of the present invention will be more apparent from the following detailed description. Hereinafter, embodiments according to the present invention will be described in detail with reference to the accompanying drawings.

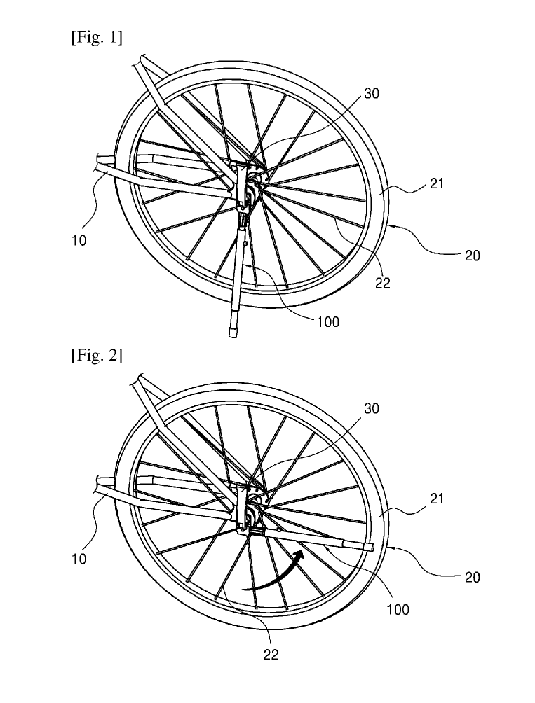

Referring to FIGS. 1 to 6, a bicycle kickstand-combined pump 100 according to an embodiment of the present invention is assembled to a bicycle by a quick release level device 30 by which a rear wheel 20 of the bicycle is assembled to a frame 10. The bicycle kickstand-combined pump 100 includes an assembly plate 110 which is tightened and assembled by the quick release level device 30, a rotating unit which is coupled to the assembly plate 110 and provided with a rotating shaft 123 so as to be rotatable between a parking position and a moving position, and a pump 140 which is installed to extend from a lower end of the rotating unit.

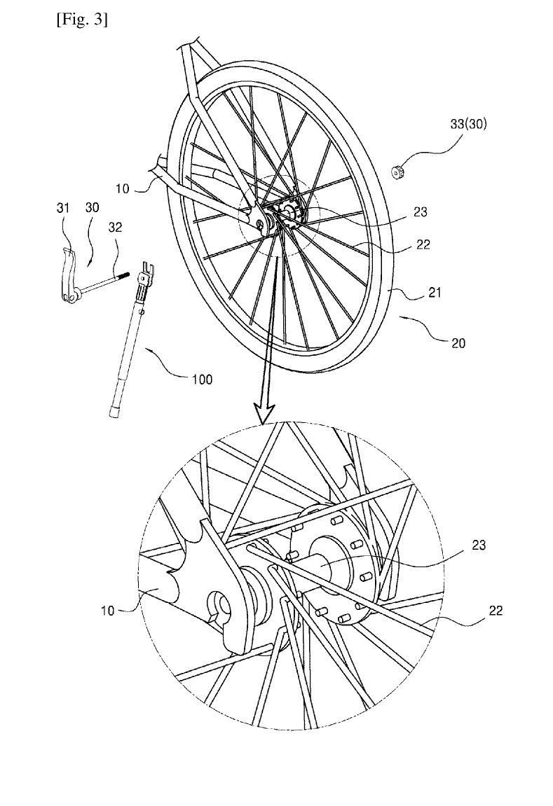

Referring to FIGS. 1 and 2, the bicycle kickstand-combined pump 100 according to the present invention may be primarily used as a kickstand. FIG. 1 shows a state in which the kickstand-combined pump 100 supports the bicycle on the ground when parking.

In FIG. 1, an upper end of the kickstand-combined pump 100 is coupled and fastened to a central portion of the rear wheel 20, and a lower end thereof comes into contact with the ground and supports the inclined bicycle.

FIG. 2 shows a state in which the upper end of the kickstand-combined pump 100 is rotated around its own position by 90 degrees and thus oriented parallel to the ground. In this state, the bicycle is allowed to move.

In FIG. 3, there is illustrated a process of installing the kickstand-combined pump 100 according to the present invention on the quick release lever device 30.

The quick release lever device 30 is a device which is widely used and has a structure for allowing a part to be literally rapidly coupled to or separated from another part. Briefly, the quick release lever device 30 include a bolt 32 provided with a lever 31 on a front end thereof, and a nut 33 coupled to the other end of the bolt 32, and is configured such that the quick release lever device 30 is tightened and fixed by tightening the bolt 32 into the nut 33 to an appropriate degree and pushing the lever 31. Due to this configuration, rapid coupling or decoupling of parts is secured.

As shown in FIG. 3, the rear wheel 20 generally includes a central hub 23, spokes 22 which are radially disposed around the central hub 23, and a tire 21 which is provided on an outer surface of a tube that is installed on a rim coupled to outer ends of the spokes 22. This rear wheel 20 is the same configuration as that of a typical bicycle rear wheel.

The present invention is applied to a bicycle that uses the quick release lever device 30 to couple the rear wheel 20 to the bicycle frame 10.

In FIG. 3, the rear wheel 20 is configured so as to be removable from the frame 10 by the quick release lever device 30. The bicycle kickstand-combined pump 100 according to the present invention is mounted, along with the rear wheel 20, to the frame 10 by the quick release lever device 30.

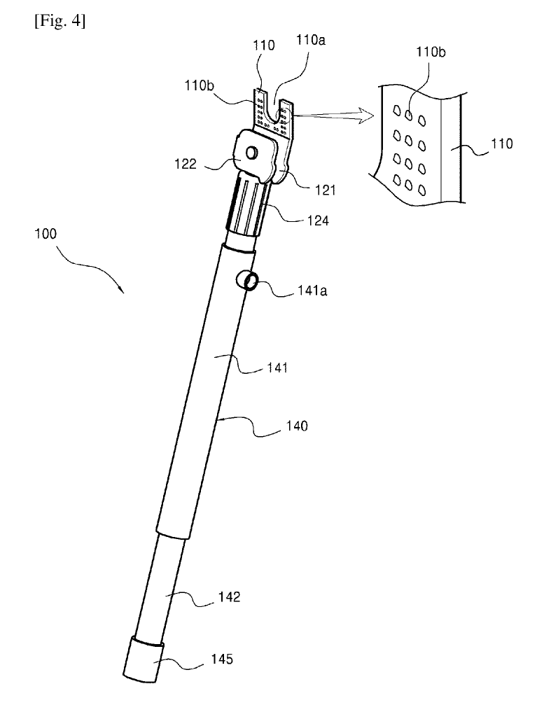

Referring to FIG. 4, there is illustrated a perspective view of the bicycle kickstand-combined pump 100 according to the present invention.

The assembly plate 110 is a planar member having a U-shaped notch 110a in an upper end thereof. Of course, the bolt 32 of the quick release lever device 30 is inserted into the U-shaped notch 110a. The assembly plate 110 is tightened by the quick release lever device 30 and thus fastened to the bicycle frame 10.

Therefore, the bicycle kickstand-combined pump 100 can be rapidly separated from the bicycle merely by releasing the quick release lever 30.

The assembly plate 110 has a plurality of small protrusions 110b that function to increase frictional force with another part making contact therewith after assembling and thereby reliably retain the assembled state.

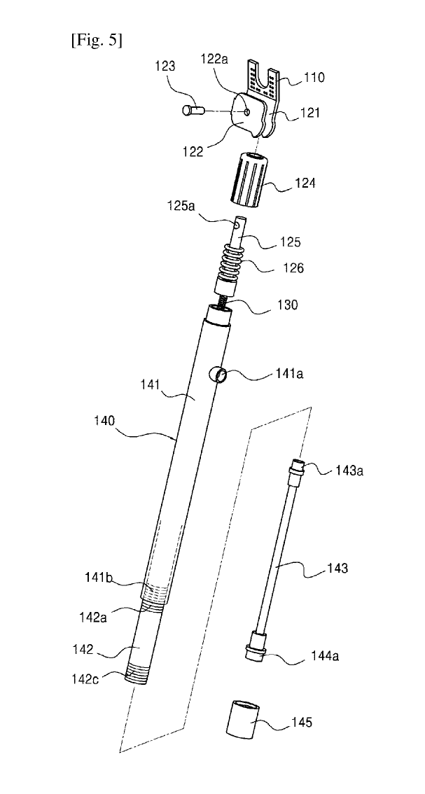

The rotating unit is installed below the assembly plate 110. Referring to FIGS. 4 and 5, the rotating unit includes a lever 125 which is installed between two fastening plates 121 and 122 so as to be rotatable by the rotating shaft 123, a spring 126 which is fitted over an outer surface of the lever 125, and a cap 124 which is also fitted over the outer surface of the lever 125 and supported by the spring 126. Therefore, when the lever 125 is forcibly pushed, it is allowed to change in position between the parking position of FIG. 1 and the moving position of FIG. 2 while overcoming the elastic force of the spring 126. This configuration is well known in the related art; therefore, further explanation will be omitted.

Referring to FIG. 5, an upper end of the pump 140 is inserted into a lower end of the cap 124 that is a lower end of the rotating unit. The lower end of the lever 125 and the upper end of the pump 140 are coupled to each other by a tension spring 130. It is preferable that a tension spring having a relatively large tensile force be used as the tension spring 130.

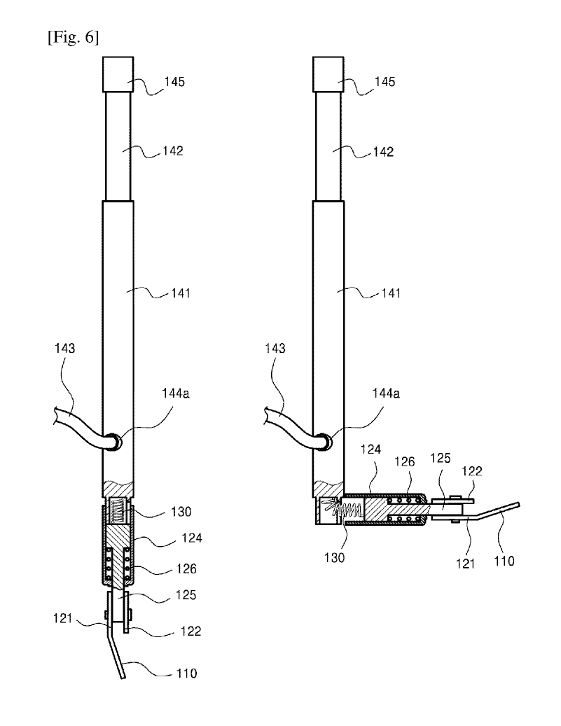

Due to this configuration, the operation shown in FIG. 6 is possible. In detail, when the entirety of the rotating unit is pulled downward in FIG. 6, the tension spring 130 extends, whereby the cap 124 is also separated from the upper end of the pump 140. In this state, when the rotating unit is bent by 90 degrees, it becomes as shown in the right view of FIG. 6. In the 90-degree bent state, a user may step on the rotating unit and use the pump 140. In this regard, a depression is formed in the upper end of the pump 140 in which the extension spring is disposed, so that when the extension spring is bent by 90 degrees, it can pass therethrough.

As such, when the pump is used, it enables the user to step on a portion thereof, whereby the maximum allowed pump pressure can be increased. In other words, compared to the case where the user uses his/her one hand to fix a cylinder pipe 141 and uses the other hand to reciprocate a piston pipe 142, the pressure which can be generated by the pump 140 is increased.

Referring to FIG. 5, the pump 140 includes the upper cylinder pipe 141 and the piston pipe 142 which is inserted into the cylinder pipe 141. An air discharge port 141a is formed on a side surface of the upper end of the cylinder pipe 141. Furthermore, the piston pipe 142 is configured such that a hose 143 having connectors 143a and 144a on opposite ends thereof can be received in the piston pipe 142. After the hose 143 has been received in the piston pipe 142, a lower end of the piston pipe 142 is closed with a stopper 145 by threaded-coupling using a threaded part 142c. The stopper 145 is preferably made of steel.

Thread parts 141b and 142a are respectively formed on an inner surface of the cylinder pipe 141 and an outer surface of the piston pipe 142 of the pump 140, thus preventing the piston 142 from being moved downward by its own weight.

The bicycle kickstand-combined pump 100 having the above-mentioned configuration can be rapidly assembled to or separated from the bicycle by the quick release lever device 30. Particularly, when the bicycle kickstand-combined pump 100 separated from the bicycle is used as a pump, because the user can bend a portion of the pump 100 by 90 degrees and step on the bent portion, the pump 100 can generate high pressure.

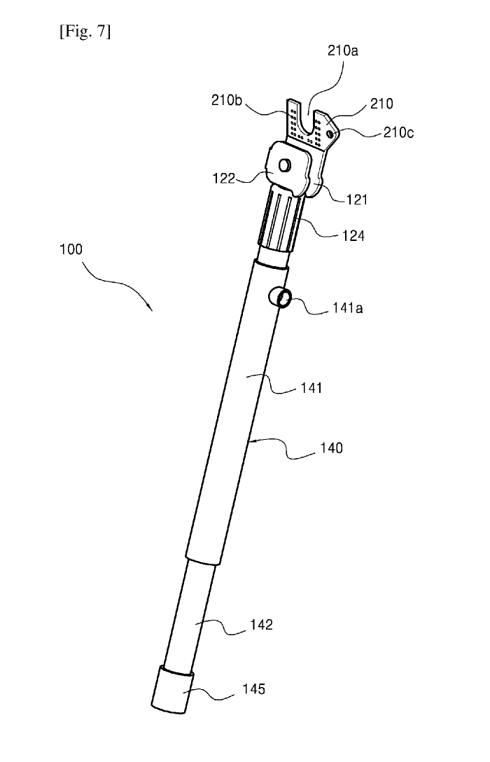

In FIG. 7, there is illustrated a second embodiment according to the present invention. As shown in the drawing, the general shape of the second embodiment is the same as that of the first embodiment. However, there is a difference in that the assembly plate 210 has a wire hole 210c for insertion of a wire of a locking device. The configuration having the wire hole 210c can be used for anti-theft purpose.

Furthermore, in lieu of the locking hole, a locking device may be integrally formed on the assembly plate, of course.

That is, the assembly plate 210 is formed of a planar member having a U-shaped notch 210a, and a plurality of protrusions 210b are formed on the surface thereof. When the assembly plate 210 is assembled by the quick release lever 30, a portion of the assembly plate 210 protrudes outward, and the wire hole 210c is formed in the protruding portion.

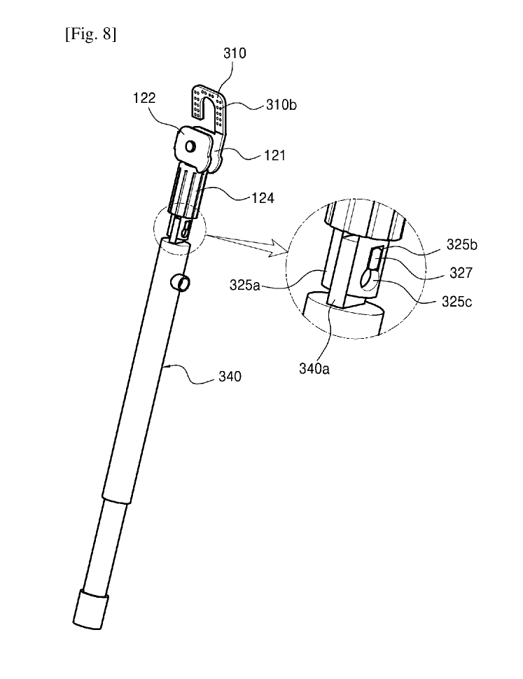

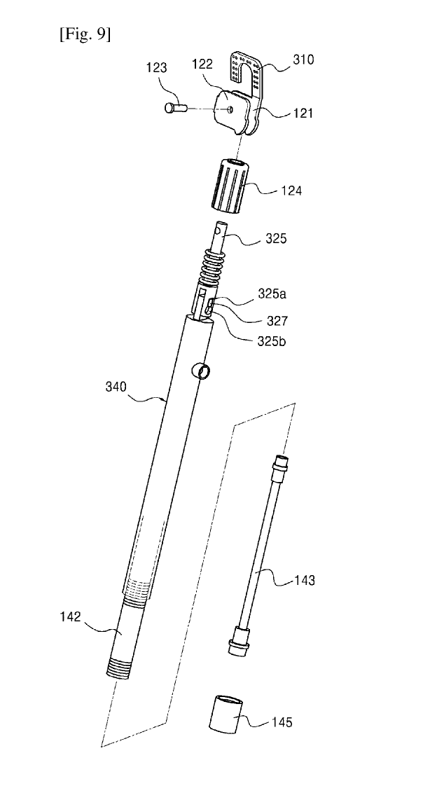

FIGS. 8 and 9 illustrate a bicycle kickstand-combined pump 340 according to a third embodiment of the present invention. As shown in the drawing, in the third embodiment, the assembly plate 310 has a hook shape, while a plurality of small protrusions 310b are formed on the surface thereof in the same manner as that of the preceding embodiments.

Particularly, hinge members 325a and 340a respectively protrude from the lower end of the lever 325 and the upper end of the pump 340 and are coupled to each other so as to be rotatable by a hinge shaft 327. A hole is formed in the hinge member 325a, and the hole includes a rectangular hole 325b formed at an upper position, and a circular hole 325c formed at a lower position. An end of the hinge shaft 327 is formed in a rectangular shape.

In more detail, a medial portion of the hinge shaft 327 has a circular cross-section, and opposite ends thereof have a rectangular cross-section. Therefore, when the hinge shaft 327 is disposed in the upper rectangular hole 325b, it cannot rotate, but when it is disposed in the lower circular hole 325c, it is allowed to rotate.

If the kickstand-combined pump 340 stands upright while making contact with the ground for the use of a kickstand, the hinge shaft 327 is disposed in the rectangular hole 325b and thus not allowed to rotate. Therefore, the kickstand-combined pump 340 can reliably function as a kickstand. Of course, when the kickstand-combined pump 340 is used as a pump, the hinge shaft 327 is disposed in the circular hole 325c. Then, the pump 340 can be bent in the same manner as that of the first embodiment, so as to enable the user to step on the bent portion and use it as a pump.

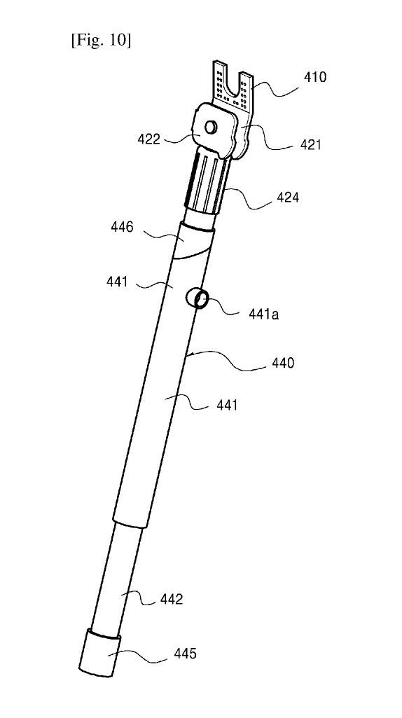

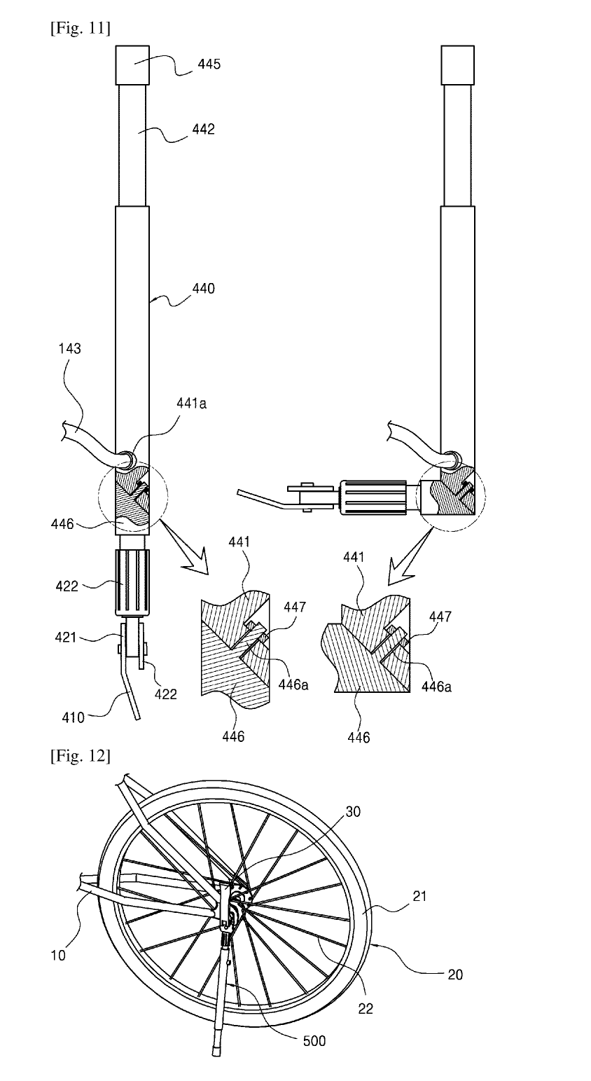

In FIGS. 10 and 11, there is illustrated a bicycle kickstand-combined pump 440 according to a fourth embodiment of the present invention.

As shown in the drawings, in the bicycle kickstand-combined pump 440, a cylinder pipe 441 is cut at 45 degrees and divided into a first pipe 441 and a second pipe 446 which have cut surfaces. Therefore, the first and second pipes 441 and 446 can be rotated on the cut surfaces by 90 degrees. In this case, the user can step on the rotated portion and use the pump.

In this embodiment, a rotating shaft 446a protrudes from the second pipe 446, and a through hole into which the rotating shaft 446a is inserted is formed in the first pipe 441. A nut member 447 is installed on an end of the through hole. Of course, there is no threaded part in the through hole so as to allow the rotating shaft 446a to rotate in the through hole.

Moreover, a cylinder is formed in only the first pipe 441 without being formed in the second pipe 446.

Hereinafter, a detachable pump according to an embodiment of the present invention will be described in detail with reference to the accompanying drawings.

As shown in FIGS. 11 to 16, a kickstand 500 having a detachable pump according to a first embodiment of the present invention is assembled to a bicycle by a quick release lever device 30 by which a rear wheel 20 of the bicycle is assembled to the frame 10. The kickstand 500 includes an assembly plate 510 which is fastened and assembled by the quick release lever device 30, a rotating unit 520 which is coupled to the assembly plate 510 and provided with a rotating shaft 523 so as to be rotatable between a parking position and a moving position, and a pump 540 which is detachably assembled to a lower end of the rotating unit 520 so as to be assemblable with and disassemblable from each other.

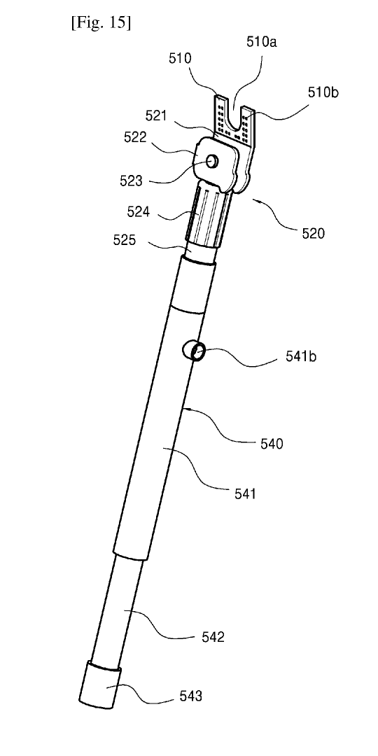

Referring to FIG. 15, a plurality of protrusions 510b are provided on the assembly plate 510 to increase frictional force and prevent the assembly plate 510 from being undesirably removed after it has been assembled with the bicycle.

Furthermore, referring to FIG. 5, an air discharge port 541b through which compressed air is discharged from the pump 540 is provided on a side surface of a cylinder pipe 541 that is a pump body.

Threaded parts (not shown) are respectively formed on an inner surface of the cylinder pipe 541 and an outer surface of a piston pipe 542 of the pump 140, thus preventing the piston pipe 542 from being moved downward by its own weight.

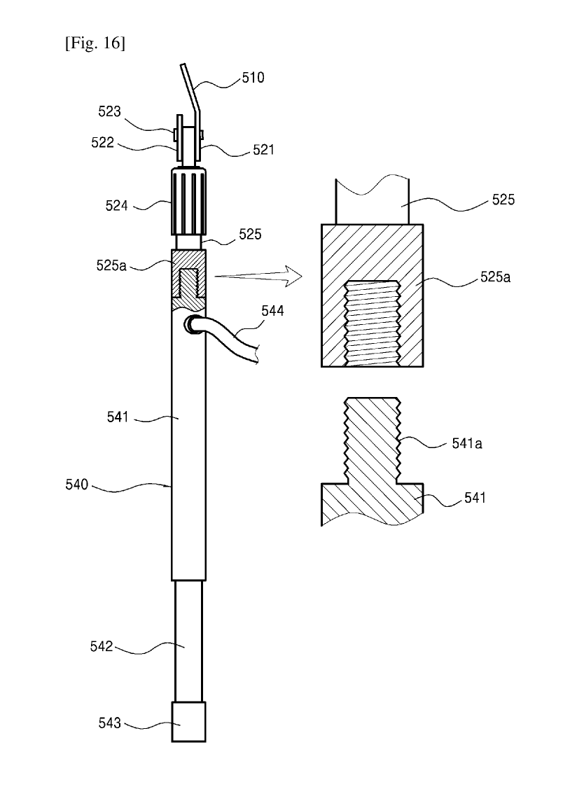

Particularly, referring to FIG. 16, a nut 525a is provided on a lower end of the rotating unit 520, and a bolt 541a is provided on an upper end of the pump 540 so that they are assembled with each other.

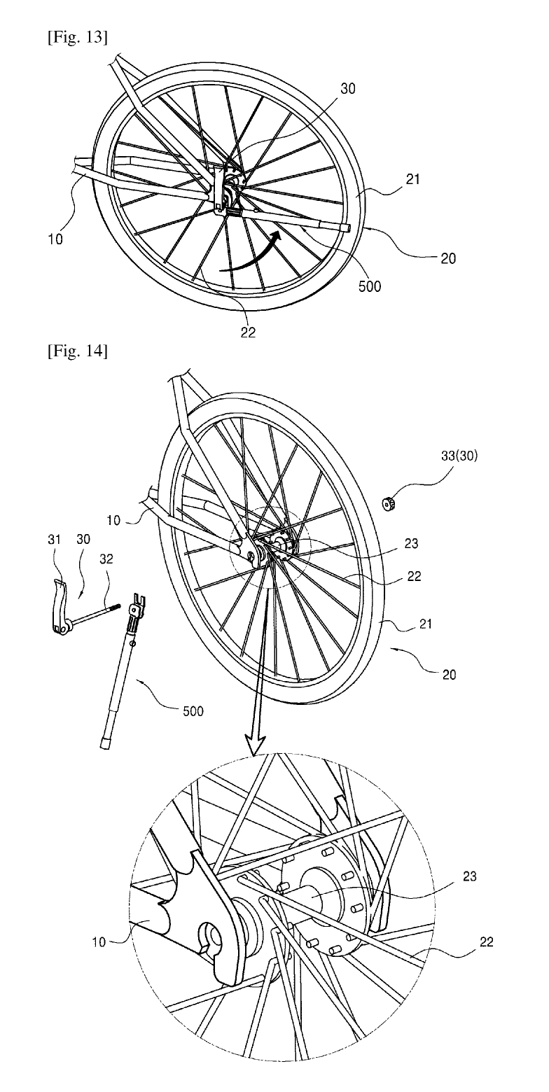

Referring to FIGS. 12 and 13, the kickstand 500 having the detachable pump according to the present invention may be primarily used as a kickstand. FIG. 12 shows a state in which the kickstand 500 supports the bicycle on the ground when parking.

In FIG. 12, an upper end of the kickstand 500 is coupled and fastened to a central portion of the rear wheel 20, and a lower end thereof comes into contact with the ground and supports the inclined bicycle.

FIG. 13 shows a state in which the upper end of the kickstand 500 is rotated around its own position by 90 degrees and thus oriented parallel to the ground. In this state, the bicycle is allowed to move.

In FIG. 14, there is illustrated a process of installing the kickstand 500 according to the present invention on the quick release lever device 30.

The quick release lever device 30 is a device which is widely used and has a structure for allowing a part to be literally rapidly coupled to or separated from another part. Briefly, the quick release lever device 30 include a bolt 32 provided with a lever 31 on a front end thereof, and a nut 33 coupled to the other end of the bolt 32, and is configured such that the quick release lever device 30 is tightened and fixed by tightening the bolt 32 into the nut 33 to an appropriate degree and pushing the lever 31. Due to this configuration, rapid coupling or decoupling of parts is secured.

As shown in FIG. 14, the rear wheel 20 generally includes a central hub 23, spokes 22 which are radially disposed around the central hub 23, and a tire 21 which is provided on an outer surface of a tube that is installed on a rim coupled to outer ends of the spokes 22. This rear wheel 20 is the same configuration as that of a typical bicycle rear wheel.

The present invention is applied to a bicycle that uses the quick release lever device 30 to couple the rear wheel 20 to a bicycle frame 10.

In FIG. 14, the rear wheel 20 is configured so as to be removable from the frame 10 by the quick release lever device 30. The kickstand 500 having the detachable pump according to the present invention is mounted, along with the rear wheel 20, to the frame 10 by the quick release lever device 30.

Referring to FIG. 15, the kickstand 500 is mounted to the bicycle as the assembly plate 510 is coupled and mounted to the bicycle by the quick release lever device 30.

The assembly plate 510 is a planar member having a U-shaped notch 510a in an upper end thereof. Of course, the bolt 32 of the quick release lever device 30 is inserted into the U-shaped notch 510a. The assembly plate 510 is tightened by the quick release lever device 30 and thus fastened to the bicycle frame 10.

Therefore, the kickstand 500 can be rapidly separated from the bicycle merely by releasing the quick release lever 30.

The assembly plate 510 has a plurality of small protrusions 510b that function to increase frictional force with another part making contact therewith after assembling and thereby reliably retain the assembled state.

The rotating unit 520 is installed below the assembly plate 510. Referring to FIGS. 15 and 16, the rotating unit 520 includes a lever 525 which is installed between two fastening plates 521 and 522 so as to be rotatable by the rotating shaft 523, a spring (not shown) which is fitted over an outer surface of the lever 525, and a cap 524 which is also fitted over the outer surface of the lever 525 and supported by the spring. Therefore, when the lever 525 is forcibly pushed, it is allowed to change in position between the parking position of FIG. 12 and the moving position of FIG. 13 while overcoming the elastic force of the spring. This configuration is well known in the related art; therefore, further explanation will be omitted.

Referring to FIG. 16, the nut 525a is provided on the lower end of the lever 525, and the bolt 541a which is assembled with the nut 525a is provided on the upper end of the pump 540, that is, the upper end of the cylinder pipe 541. Due to this configuration, the entirety of the pump 540 can be assembled to or disassembled from the rotating unit 520. Furthermore, the separation of the pump 540 can be performed not only rapidly but also easily and conveniently.

Therefore, the user uses the kickstand for its intended purpose under normal conditions. To use the pump 540, if the user rotates the pump 540 and separates the bolt 541a and the nut 525a from each other, the pump 540 can be easily completely separated from the bicycle. Then, the user can use the pump 540 to inject air into the tire.

The pump 540 can be manufactured by remodeling an upper end of a typical pump. The pump 540 having the same structure as that of the typical pump includes the upper cylinder pipe 541, and the piston pipe 542 which is inserted into the cylinder pipe 541 and reciprocates to compress air and supply it to a target.

A stopper 543 is fitted over the lower end of the piston pipe 542. The stopper 543 is a part which comes into contact with the ground when the kickstand is used for its intended purpose. Preferably, the stopper 543 is made of steel.

Particularly, the air discharge port 541b is provided on the upper end of the pump cylinder pipe 541. In this embodiment, the air discharge port 541b is provided on the side surface of the cylinder pipe 541. A hose 544, which is received in the piston pipe 542 under normal conditions, may be coupled to the air discharge port 54b so as to pump up the tire.

In FIG. 16, there is illustrated the case where the hose 544 is coupled to the air discharge port 541b. When it is desired to use the pump, the bolt 541a is removed from the nut 525a.

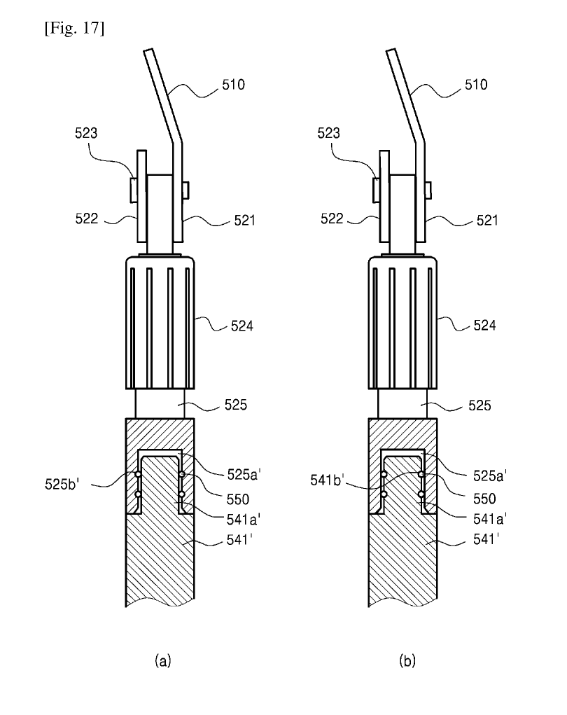

A partial sectional view of a kickstand according to a second embodiment of the present invention is shown in FIG. 17. As shown in the drawing, a central depression 525a′ is formed in a central portion of the lower end of the lever 525. A central protrusion 541a′ is provided on the upper end of the cylinder pipe 541′ of the pump and configured to be inserted into the central depression 525a′. A plurality of O-rings 550 are provided on an outer surface of the central protrusion 541a′ by force-fitting.

Two kinds of methods may be used for installation of the O-rings 550. In the case of (a), circumferential grooves 525b′ are circumferentially formed in an inner surface of the central depression 525a′ at positions at which the O-rings 550 are disposed. In the case of (b), circumferential grooves 541b′ are formed in the outer surface of the central protrusion 541a′, and the O-rings 550 are installed in the circumferential grooves 541b′.

With the O-rings installed in the above-mentioned manner, the upper end of the pump cylinder pipe 541′ is pushed and inserted into the central depression 525′a of the lever 525 or pulled and removed therefrom.

Because the O-rings 550 are made of rubber, the assembly or disassembly of the corresponding parts is performed in a force-fitting manner using high frictional force.

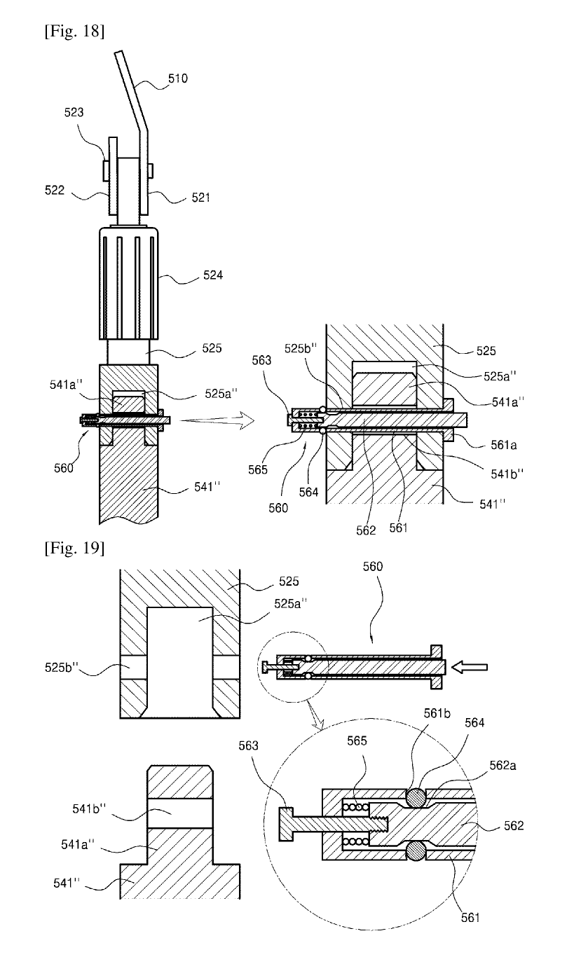

Partial sectional views of a kickstand according to a third embodiment of the present invention are shown in FIGS. 18 and 19. As shown in the drawing, a central depression 525a″ is formed in a central portion of the lower end of the lever 525. A central protrusion 541a″ is provided on the upper end of the cylinder pipe 541″ of the pump and configured to be inserted into the central depression 525a″.

A locking pin 560 is assembled passing through the central depression 525″ and the central protrusion 541a″.

If the locking pin 560 is inserted into the central depression 525a″ and through holes 525b″ and 541b″ of the central protrusion 541a″, the lever 525 and the pump 540 are coupled and fastened to each other and thus integrally operated while having a linear shape.

The locking pin 560 includes an outer pipe 561 which is provided with a stop protrusion 561a on one end thereof, an operating rod 562 which is inserted into the outer pipe 561, a spring 565 which elastically pushes the operating rod 562 outward, a locking bolt 563 which is fixed to one end of the operating rod 562 and configured to prevent the operating rod 562 from being undesirably removed from the outer pipe 561, and a plurality of balls 564 which are inserted into respective side holes 561b formed in a side surface of the outer pipe 561.

Particularly, when the locking pin 560 is at a locked position, a portion of each ball 564 is disposed in the corresponding side hole 561b of the outer pipe 561, and another portion thereof protrudes outward from the side hole 561b. When the locking pin 560 is at a separation position, the ball 564 is disposed in a reduced diameter part 562a of the operating rod 562 and thus completely inserted inside the side hole 561b, thus allowing the locking pin 560 to be removed from the central depression 525a″ and the central protrusion 541a″.

Referring to FIG. 18, there is illustrated a state in which the locking pin 560 is assembled and locked through the central hole 525a″ and the through holes 525b″ and 541b″ of the central protrusion 541a″. The locking pin 560 is in a state in which it is fixed by the balls 564 and the stop protrusion 561a of the outer pipe 561.

In this state, if the stop protrusion 561a or the balls 564 are displaced from the locked position thereof, the locking pin 560 is allowed to be removed from the through holes 525b″ and 541b″. Because the stop protrusion 561a is a fixed part and the balls 564 are movable, whether the locking pin 560 is in the locked state or allowed to be separated is determined by movement of the balls 564.

The balls 564 are assembled in the respective side holes 561b of the outer pipe 561. The diameter of each ball 564 is slightly larger than that of the corresponding side hole 561b so that the ball 564 can be prevented from being removed out of the outer pipe 561.

Referring to FIG. 19, there is clearly illustrated the operation of the locking pin 560. When the user pushes the operating rod 562 of the locking pin 560 while overcoming the elastic force of the spring 565, the operating rod 562 is moved to the left. Then, the balls 564 are disposed in the reduced diameter part 562a and thus completely inserted into the outer pipe 561. Thereby, the locking pin 560 is allowed to be completely removed from the through holes 525b″ and 541b″.

On the contrary to this, if the force applied to the operating rod 562 is removed, the balls 564 are returned to the original state of FIG. 18 in which they protrude outward from the outer pipe 561.

Although the locking pin 560 has a complex structure, it can be operated in a one-touch manner. Therefore, the locking pin 560 is preferably applied to a high-quality product that is relatively expensive.

Although various embodiments have been described for illustrative purposes, it will be apparent to those skilled in the art that various changes and modifications may be made without departing from the spirit and scope of the invention as defined in the following claims.

### INDUSTRIAL APPLICABILITY

The present invention can be applied to a bicycle.

1. A bicycle kickstand-combined pump assembled to a bicycle by a quick release lever device by which a rear wheel of the bicycle is assembled to a frame, the bicycle kickstand-combined pump comprising:
an assembly plate tightened and assembled by the quick release lever device;
a rotating unit coupled to the assembly plate and provided with a rotating shaft so as to be rotatable between a parking position and a moving position; and
a pump installed to extend from a lower end of the rotating unit.

2. The bicycle kickstand-combined pump according to claim 1, wherein an upper end of the pump is inserted into the lower end of the rotating unit, and a tension spring is installed therebetween.

3. The bicycle kickstand-combined pump according to claim 1, wherein hinge members respectively protrude from the lower end of the rotating unit and an upper end of the pump and are coupled to each other so as to be rotatable by a hinge shaft, wherein a hole is formed in the hinge member of the pump and has a rectangular upper part and a circular lower part, and the hinge shaft has a rectangular end.

4. The bicycle kickstand-combined pump according to claim 1, wherein a plurality of protrusions are provided on the assembly plate and thus increase frictional force to prevent the assembly plate from being removed after assembly.

5. The bicycle kickstand-combined pump according to claim 1, wherein a discharge portion is provided on a side surface of a body of the pump so that compressed air is discharged from the pump through the discharge port.

6. The bicycle kickstand-combined pump according to claim 1, wherein threaded parts are formed on an inner surface of a cylinder pipe of the pump and an outer surface of a piston pipe of the pump so that the piston pipe is prevented from being moved downward by its own weight.

7. The bicycle kickstand-combined pump according to claim 1, wherein a wire hole is formed in the assembly plate so that a wire of a locking device for anti-theft purpose can pass through the assembly plate through the wire hole.

8. A kickstand having a detachable pump, assembled to a bicycle by a quick release lever device by which a rear wheel of the bicycle is assembled to a frame, the kickstand comprising:
an assembly plate tightened and assembled by the quick release lever device;
a rotating unit coupled to the assembly plate and provided with a rotating shaft so as to be rotatable between a parking position and a moving position; and
a pump detachably assembled to a lower end of the rotating unit so as to be assemblable with and disassemblable from each other.

9. The kickstand according to claim 8, wherein a plurality of protrusions are provided on the assembly plate and thus increase frictional force to prevent the assembly plate from being removed after assembly.

10. The kickstand according to claim 8, wherein a discharge portion is provided on a side surface of a body of the pump so that compressed air is discharged from the pump through the discharge port.

11. The kickstand according to claim 8, wherein threaded parts are formed on an inner surface of a cylinder pipe of the pump and an outer surface of a piston pipe of the pump so that the piston pipe is prevented from being moved downward by its own weight.

12. The kickstand according to claim 8, wherein a nut is provided on any one of the lower end of the rotating unit and an upper end of the pump, and a bolt is provided on the other so that the rotating unit and the pump are assembled with each other.

13. The kickstand according to claim 8, wherein a central depression is formed in a central portion of the lower end of the rotating unit, and a central protrusion is provided on an upper end of the pump and inserted into the central depression, wherein a plurality of O-rings are fitted over an outer surface of the central protrusion so that the rotating unit and the pump are assembled with each other by force-fitting.

14. The kickstand according to claim 8, wherein a central depression is formed in a central portion of the lower end of the rotating unit, a central protrusion is provided on an upper end of the pump and inserted into the central depression, and a locking pin is assembled with the rotating unit and the pump through the central depression and the central protrusion, wherein the locking unit comprises:
an outer pipe provided with a stop protrusion on an end thereof;
an operating rod inserted into the outer pipe;
a spring configured to push the operating rod outward;
a locking bolt fixed to an end of the operating rod and configured to prevent the operating rod from being removed from the outer pipe; and
a plurality of balls inserted into a plurality of side holes formed in a side surface of the outer pipe, and
wherein when the locking pin is at a locked position, a portion of each of the balls is disposed in the corresponding side hole of the outer pipe, and another portion thereof protrudes outward from the side hole, and when the locking pin is at a separation position, the ball is disposed in a reduced diameter part of the operating rod and thus completely inserted inside the side hole so as to allow the locking pin to be removed from the central depression and the central protrusion.
